(19) United States
(12) Patent Application Publication
(10) Pub. No.: US 2015/0027378 A1
(43) Pub. Date: Jan. 29, 2015

(54) Feeding Tool

(71) Applicant: Elive LLC, New Berlin, WI (US)

(72) Inventor: Thomas Lutz, Cedar Rapids, IA (US)

(21) Appl. No.: 14/339,065

(22) Filed: Jul. 23, 2014

Related U.S. Application Data
(60) Provisional application No. 61/857,585, filed on Jul. 23, 2013.

(51) Int. Cl. A01K 5/02

(52) U.S. Cl. CPC A01K 5/02
USPC 119/57.92

(57) ABSTRACT

A feeding tool for dispensing pet food out of a pet food container includes an adapter having a first aperture. The adapter is configured to be coupled to a container of pet food. The feeding tool also includes an actuator coupled to the adapter. The actuator is movable between a first position and a second position. The feeding tool also includes a control member coupled to the actuator. The control member includes a second aperture. The feeding tool also includes a cap coupled to the actuator. The cap includes a third aperture. The first and second apertures are aligned with one another in the first position to allow food to pass from the container into the actuator, and the second and third apertures are aligned with one another in the second position to allow food to pass from the actuator out of the cap.

### CROSS-REFERENCE TO RELATED APPLICATIONS

This application claims priority to U.S. Provisional Application No. 61/857,585, filed Jul. 23, 2013, the entire contents of which are incorporated herein by reference.

### BACKGROUND

The present invention relates to a feeding tool for small pets, such as fish. Food is often provided for certain small pets, such as fish in the form of flakes or pellets. The food is often delivered using a shaker that the pet owner shakes into the animal's habitat to deliver a desired amount of food. Often, the quantity of food is estimated based on the owner's experience. This can result in the delivery of too much or too little food.

### SUMMARY

In accordance with one construction, a feeding tool for dispensing pet food out of a pet food container includes an adapter having a first aperture. The adapter is configured to be coupled to a container of pet food. The feeding tool also includes an actuator coupled to the adapter. The actuator is movable between a first position and a second position. The feeding tool also includes a control member coupled to the actuator. The control member includes a second aperture. The feeding tool also includes a cap coupled to the actuator. The cap includes a third aperture. The first and second apertures are aligned with one another in the first position to allow food to pass from the container into the actuator, and the second and third apertures are aligned with one another in the second position to allow food to pass from the actuator out of the cap.

In accordance with another construction, a feeding tool for dispensing pet food out of a pet food container includes an adapter having a first aperture. The adapter is configured to couple to a container of pet food. The feeding tool also includes an actuator coupled to the adapter and movable between a first position and a second position. The feeding tool also includes a plurality of separate control members configured to be coupled to the actuator. Each control member includes a second aperture of different size. The feeding tool also includes a cap coupled to the actuator, the cap including a third aperture. At least one of the plurality of control members is configured to be coupled to the cap.

In accordance with another construction, a tool for dispensing dry goods includes a container sized to contain a quantity of dry goods, and an actuator including a first aperture sized to hold a predetermined quantity of the dry goods. The actuator is coupled to the container and is movable between a first position in which dry goods pass from the container to the first aperture and a second position in which dry goods cannot pass from the container to the first aperture. A cap is coupled to the container and supports the actuator for movement relative thereto. The cap defines a second aperture that is not aligned with the first aperture when the actuator is in the first position and is aligned with the first aperture when the actuator is in the second position to receive the dry goods from the first aperture.

Other aspects of the invention will become apparent by consideration of the detailed description and accompanying drawings.

### BRIEF DESCRIPTION OF THE DRAWINGS

FIG. 1 is a perspective view of a feeding tool embodying the invention;

FIG. 2 is an exploded view of a portion of the feeding tool of FIG. 1;

FIG. 3 is another exploded view of a portion of the feeding tool of FIG. 1;

FIG. 4 is an exploded view of an actuator and control member of the feeding tool of FIG. 1;

FIG. 5 is a partially broken away view of a portion of the feeding tool of FIG. 1;

FIG. 6 is a bottom view of a cover for the feeding tool of FIG. 1 with the actuator in a non-actuated position;

FIG. 7 is a section view of a portion of the feeding tool of FIG. 1 with the actuator in the non-actuated position;

FIG. 8 is a bottom view of a cover for the feeding tool of FIG. 1 with the actuator in the an actuated position;

FIG. 9 is a section view of a portion of the feeding tool of FIG. 1 with the actuator in the actuated position;

FIG. 10 is a section view of a portion of the feeding tool of FIG. 1 illustrating a first and second control member support;

FIG. 11 is a perspective view of another feeding tool embodying the invention;

FIG. 12 is a section view of the feeding tool of FIG. 11 arranged to deliver pelleted food and in a non-actuated position;

FIG. 13 is a section view of the feeding tool of FIG. 11 arranged to deliver pelleted food and in an actuated position;

FIG. 14 is a section view of the feeding tool of FIG. 11 arranged to deliver pelleted food after returning to the non-actuated position;

FIG. 15 is a section view of the feeding tool of FIG. 11 arranged to deliver flaked food and in a non-actuated position;

FIG. 16 is a section view of the feeding tool of FIG. 11 arranged to deliver flaked food and in a first actuated position;

FIG. 17 is a section view of the feeding tool of FIG. 11 arranged to deliver flaked food and in a second actuated position; and

FIG. 18 is a section view of the feeding tool of FIG. 11 arranged to deliver flaked food and in a third actuated position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited.

### DETAILED DESCRIPTION

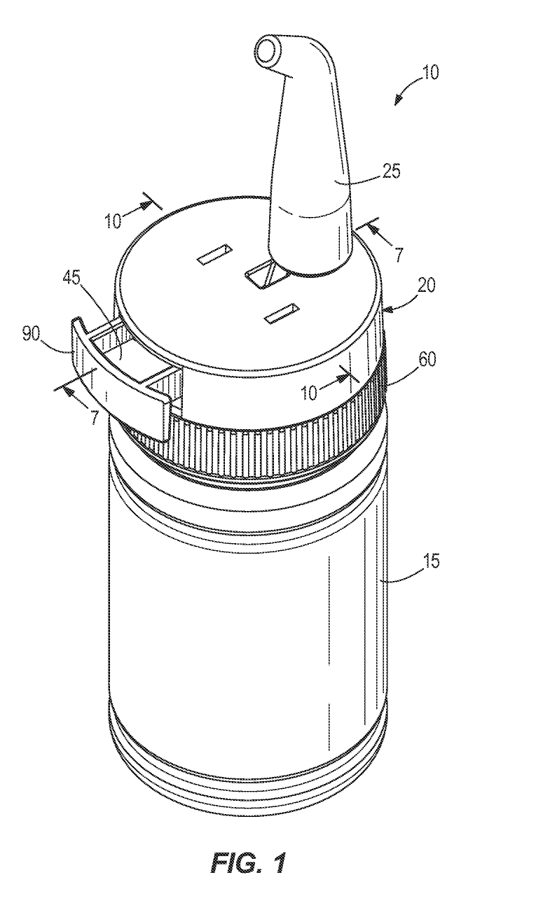

FIG. 1 illustrates a feeding tool 10 including a container 15, a cover 20, and an extension 25. In the illustrated construction the feeding tool 10 includes the container 15. In other constructions the feeding tool 10 is a separate component that attaches to the container 15 or other containers as may be desired. In the illustrated construction the container 15 is sized to contain a supply of pet food, preferably fish food, in the form of flakes 30 or pellets 35 (FIGS. 15-18 and FIGS. 12-14 respectively). The illustrated extension 25 is a tube that attaches to the cover 20 to aid in delivering the food in tight spaces. The extension 25 is useful in commercial environments where fish tanks are stacked on top of one another with only a small space disposed between the bottom of one tank and the open top of another tank directly below. The extension 25 fits within such a small space, allowing for the easy delivery of food with minimal spillage.

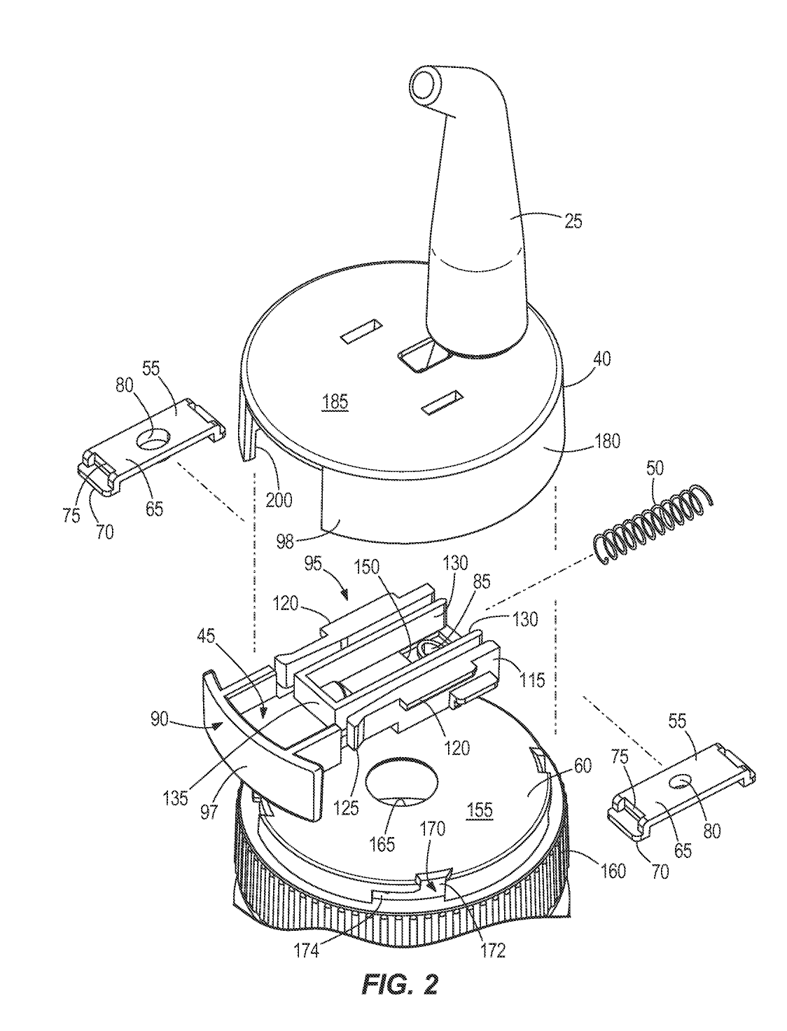

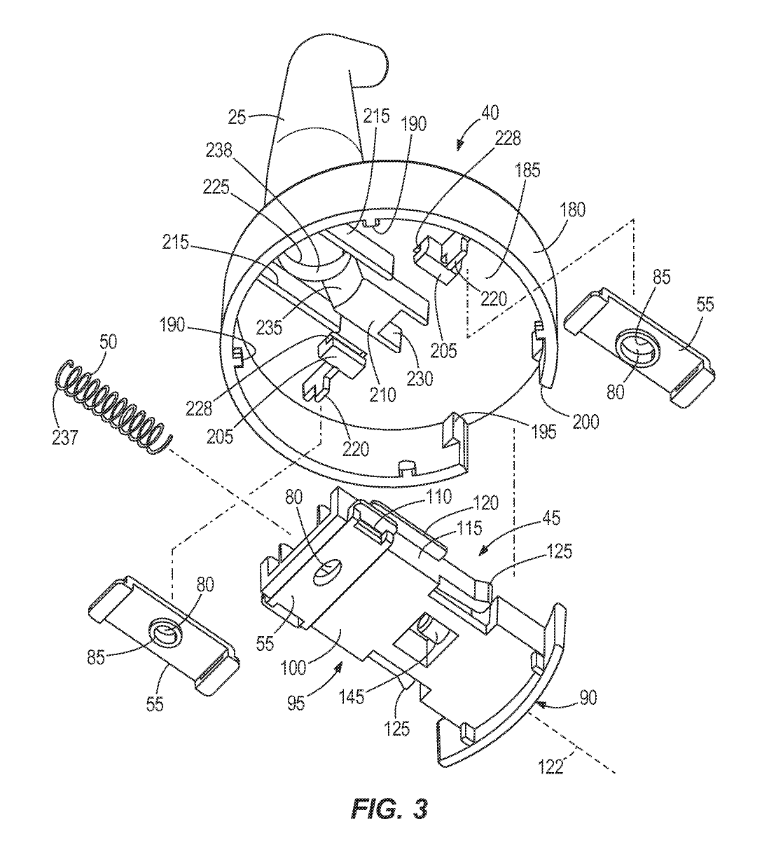

FIGS. 2 and 3 are exploded views of the cover 20 illustrating various components of the cover 20. With reference to FIGS. 1-3, the cover 20 includes a cap 40, an actuator 45, a biasing member 50, and a plurality of control members 55. In the illustrated construction, the cover 20 engages a container adapter 60, and the container adapter 60 engages the container 15. In the illustrated construction the biasing member 50 is a coil spring, although other constructions include different biasing members 50, as well as different arrangements of components for the cover 20.

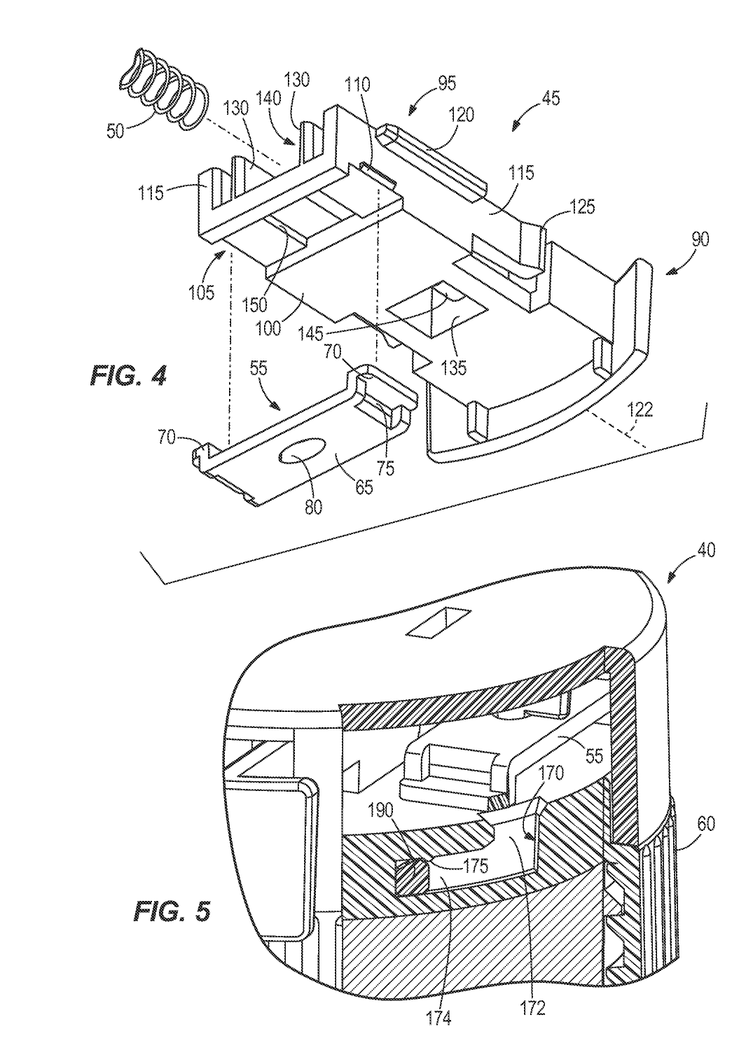

With reference to FIG. 4, each control member 55 includes a mid-section 65 in the form of an elongated rectangular portion. Attachment legs 70 are formed as part of the control member 55 and are positioned at each of the mid-section 65. The attachment legs 70 cooperate with the mid-section 65 to define rectangular apertures 75 that are arranged to engage the actuator 45. An aperture 80 is formed in the mid-section 65 and is sized to deliver a desired quantity of food.

With reference to FIG. 3, each of the apertures 80 includes a ridge 85 formed around the aperture 80 on one side. The ridge 85 is used to engage the actuator 45 to properly align the control member 55 when the control member 55 is attached to the actuator 45. In the illustrated construction, three control members 55 are provided, with each control member 55 including a differently size aperture 80. Thus, a small, medium, and large aperture 80 are provided. In other constructions, more than or fewer than three control members 55 are provided. In addition, other constructions include a single control member 55 with an adjustable aperture that provides a desired level of adjustability and control of food delivery. In some constructions the control member 55 is coupled to the actuator 45 by being integrally formed as part of (in a single piece) the actuator 45, as opposed to being a separate piece removably coupled to the actuator 45.

With reference to FIG. 2, in the illustrated construction the actuator 45 is a one-piece component that includes an interface portion 90 and an operating portion 95. The interface portion 90 includes a curved outer surface 97 that has an identical or substantially identical curvature as a curved outer surface 98 of the cap 40. The interface portion 90 extends out of the cap 40 when the cover 20 is assembled and provides a point where the user can actuate the feeding tool 10 to deliver food or other product out of the feeding tool 10. Of course, other shapes or arrangements of the interface portion 90 are possible.

With continued reference to FIGS. 3 and 4, the operating portion 95 includes a substantially planar bottom surface 100. A slot 105 (FIG. 4) that extends across the bottom surface 100 is sized to receive the mid-section 65 of one of the control members 55. The depth of the slot 105 closely matches a thickness of the mid-section 65 so that when installed, the mid-section 65 and the remainder of the bottom surface 100 are substantially planar. A pair of attachment hooks 110 are formed adjacent the slot 105 and are sized to engage (e.g., extend through) the rectangular apertures 75 of the control member 55 to hold the control member 55 in place.

With continued reference to FIGS. 3 and 4, two outer walls 115 extend upward from the planar bottom surface 100. A rail 120 is disposed at the top of each of the walls 115 with each rail 120 extending along an axis that is parallel to an axis 122 along which the actuator 45 moves when actuated. A stop member 125 is disposed at an of each of the outer walls 115 adjacent the interface portion 90. In the illustrated construction, the stop members 125 are tabs that extend outward slightly beyond the surface of the outer walls 115.

With continued reference to FIG. 4, two inner walls 130 are arranged parallel to the outer walls 115 and spaced inward of the outer walls 115. An inner wall 135 extends between a first of each of the inner walls 130 to partially enclose a biasing member space 140. A cylindrical receiving member 145 extends from the inner wall 135 along the movement axis 122 of the actuator 45 away from the interface portion 90. An aperture 150 extends through the bottom wall 100 between the two inner walls 130 and is sized to receive a portion of one of the control members 55.

With reference to FIG. 2, the container adapter 60 includes a substantially planar top surface 155 and a cylindrical sidewall 160 that extends around the top surface 155. An inlet aperture 165 extends through the top surface 155 to allow for the passage of food. A plurality of L-shaped slots 170 are disposed along the cylindrical wall 160 with each L-shaped slot 170 including a short leg 172 extending substantially vertically and a long leg 174 extending around a portion of the circumference of the sidewall 160.

With reference to FIG. 5, a bump 175 is formed in the long leg 174 and operates to hold the cover 20 in the engaged position when assembled. The sidewall 160 also includes an engagement section or sections (inside the sidewall 160, not shown) that are arranged to engage a similar engagement section or sections on the container 15. In some constructions the engagement sections include threads sized to match one another to allow attachment of the container adapter 60 to the container 15. Of course, other types of engagement structures can be used to couple the container adapter 60 to the container 15.

With reference to FIG. 3, the cap 40 includes a cylindrical outer wall 180 and a circular top surface 185 that covers the outer wall 180. The cylindrical wall 180 includes a plurality of tabs 190, with each tab 190 configured to engage one of the L-shaped slots 170 of the container adapter 60. Of course, other arrangements could be employed to attach the container adapter 60 to the cover 20. For example, a simple threaded arrangement could be employed. Each of a pair of stop tabs 195 also extends radially inwardly from the outer wall 180 adjacent an actuator aperture 200 that is formed in the outer wall 180.

With continued reference to FIG. 3, the top surface 185 of the cap 40 includes two rails 205, a boss member 210, a pair of walls 215, a pair of control member supports 220, and an outlet aperture 225. The illustrated rails 205 are L-shaped members that extend inward from the top surface 185 to define guide slots 228 that extends parallel to the axis 122.

The boss member 210 is a substantially rectangular block that extends inward from the top surface 185 in the space between the rails 205 and between the outlet aperture 225 and the actuator aperture 200. The boss member 210 extends generally parallel to the axis 122 with a pocket 230 formed in a first of the boss member 210 and a curved sloped surface 235 formed in a second, opposite of the boss member 210 adjacent the outlet aperture 225. The pocket 230 defines a rectangular space sized to receive one 237 of the biasing member 50. Each of the pair of walls 215 is positioned adjacent the outlet aperture 225 and extends from the outer wall 180 past at least a portion of the boss member 210. The surface 235 of the boss member 210 and the two walls 215 generally enclose a space 238 around the outlet aperture 225.

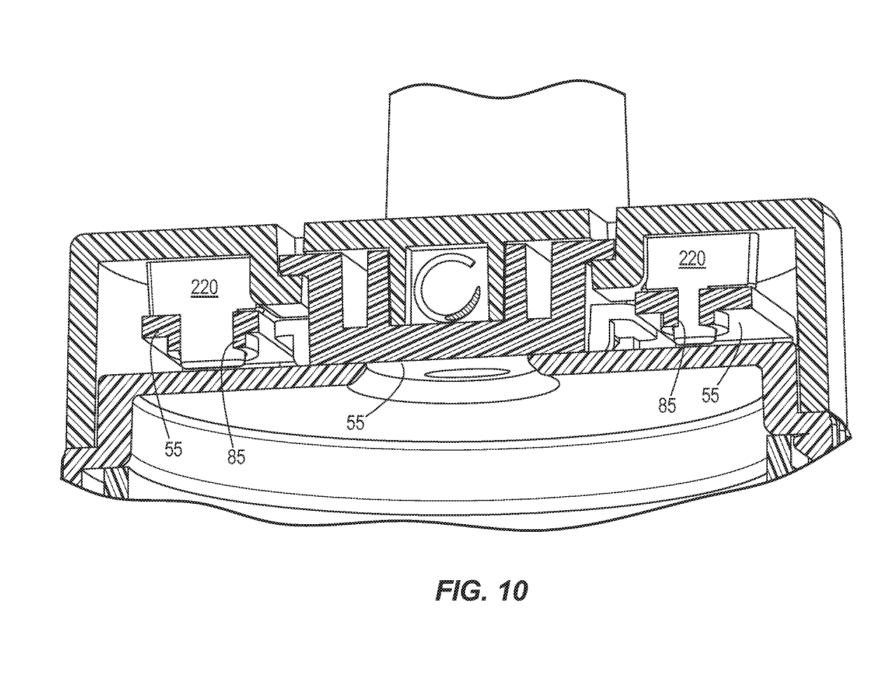

With reference to FIGS. 3 and 10, the control member supports 220 are positioned between the rails 205 and the cylindrical wall 180 such that they are in a space not occupied by the actuator member 45 when assembled. As illustrated in FIG. 10, in the illustrated construction the control member supports 220 are T-shaped, each control member support 220 having a thickness sized to support one or more unused control members 55 so that the unused control members 55 can be stored with the cover 20 when not in use.

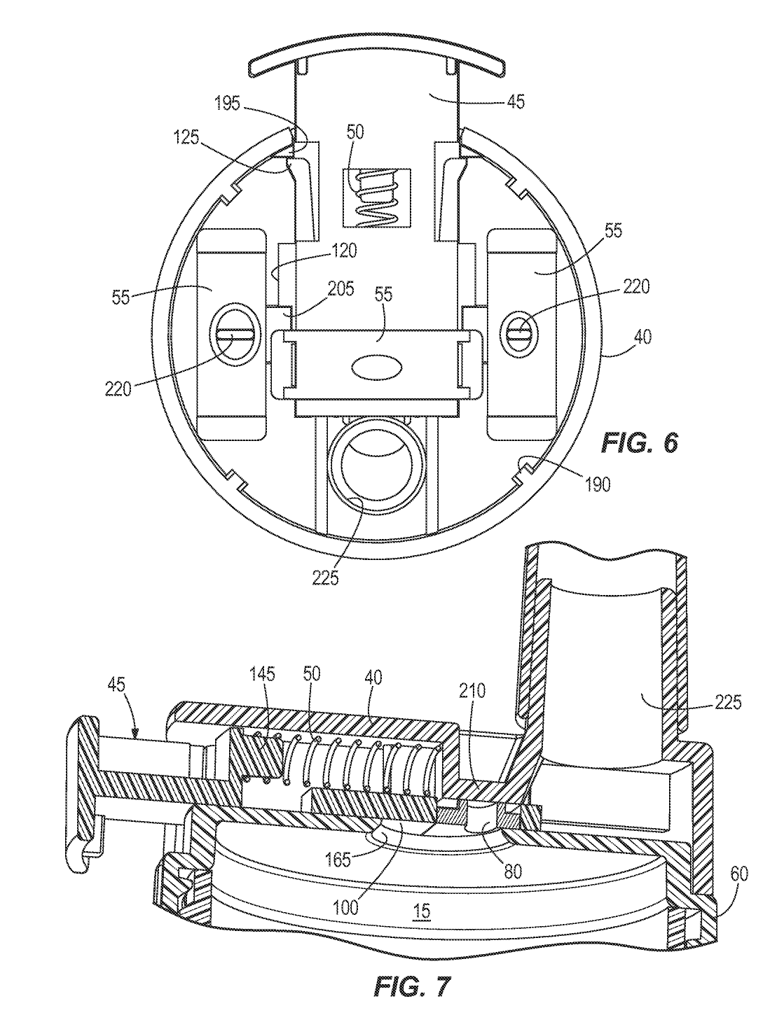

With reference to FIGS. 3, 4, and 6, to assemble the feeding tool 10, a user couples one of the control members 55 to the actuator 45. As illustrated in FIG. 4, the control member 55 fits within the slot 105 with the engagement tabs 110 snapping into the rectangular apertures 75 to hold the control member 55 in place. The biasing member 50 is placed within the space 140 between the inner walls 130 and engages the cylindrical post 145. With reference to FIG. 3, the rail members 120 are then engaged with the rails 205 (i.e., moved into the guide slots 228) with the 237 of the biasing member 50 residing in the pocket 230 formed in the boss member 210. With reference to FIG. 6, the actuator member 45 is then pushed into the actuator aperture 200 until the stop members 125 on the outer walls 115 of the actuator 45 pass the stop tabs 195 on the cylindrical wall 180.

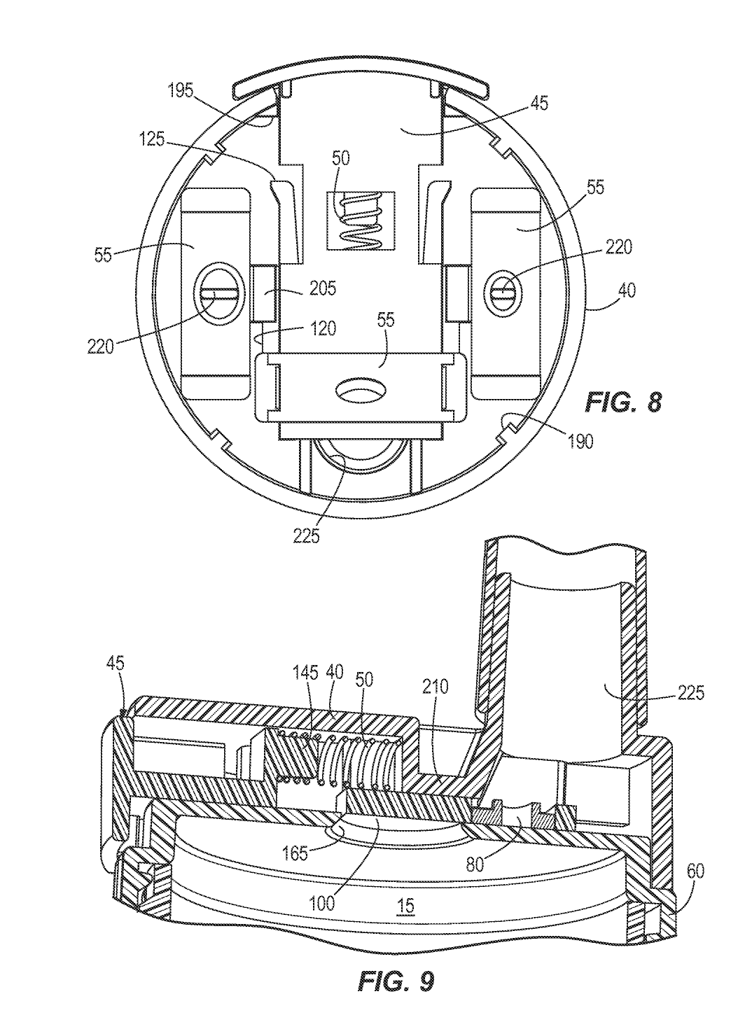

With reference to FIGS. 6-9, the operation of the feeding tool 10 will be described. FIGS. 6 and 7 illustrate the tool 10 in a non-actuated position. As illustrated in FIG. 6, the biasing member 50 biases the tool 10 toward the non-actuated position. In this position, as illustrated in FIG. 7, the control member aperture 80 is aligned with the aperture 165 in the container adapter 60. Thus, with the container 15 inverted, a quantity of food will fall into the aperture 80 of the control member 55. The user then actuates the actuator member 45 to move the actuator member 45 to the actuated position illustrated in FIGS. 8 and 9. As the actuator member 45 moves, the aperture 80 of the control member 55 slides over the top surface 155 of the container adapter 60 and is closed off. In addition, the bottom surface 100 of the actuator member 45 closes the container adapter (inlet) aperture 165. As the actuator 45 moves further, the top of the control member aperture 80 moves off of the boss 210 and opens to the outlet aperture 225. The food then freely falls through the outlet aperture 225 and can be delivered to the animal habitat. Repeated actuation will deliver additional controlled quantities of food. Thus, a user can deliver virtually any amount of food to the habitat in a controlled manner.

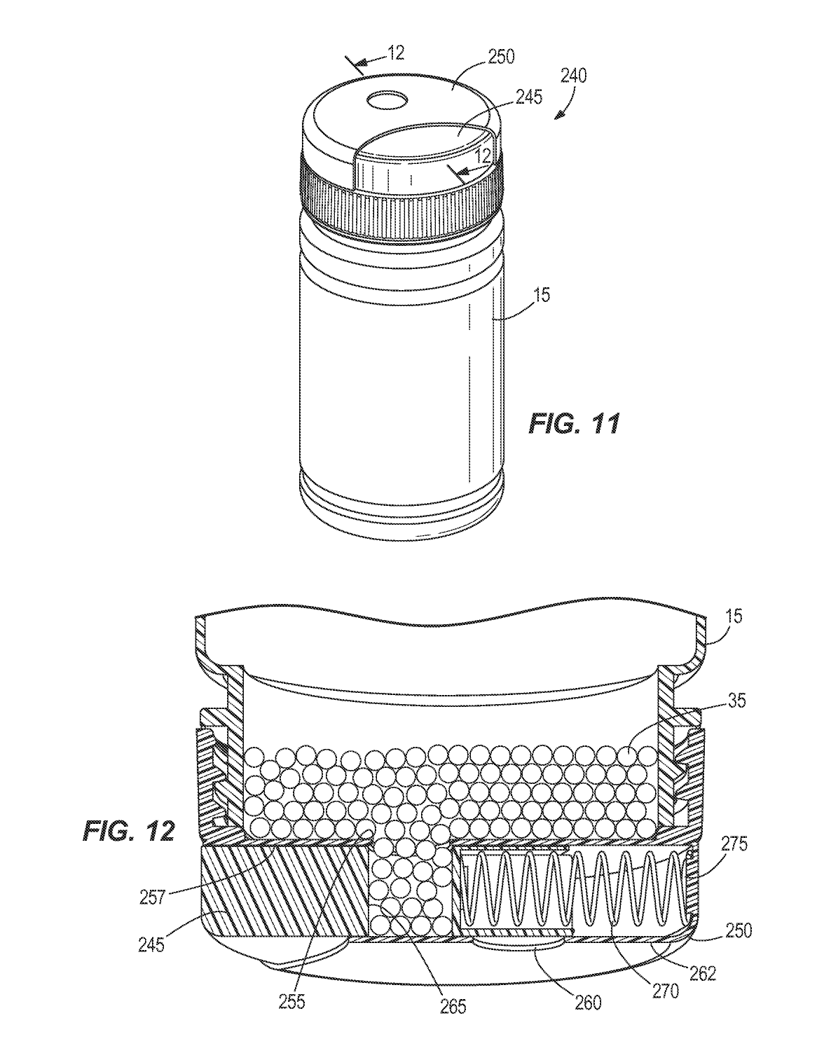

FIG. 11 illustrates another construction of a feeding tool 240 that operates in a manner similar to the feeding tool 10 of FIGS. 1-10. As can be seen, the feeding tool 240 includes an actuator 245 that is formed to fit completely within a circumference of a cap 250, thereby providing a more streamlined appearance.

FIGS. 12-14 illustrate the feeding tool 240 of FIG. 11 including the actuator 245, which is arranged to deliver pellets 35. The actuator 245 and arrangement are similar to those described with regard to FIGS. 1-10.

As shown in FIG. 12, the cap 250 includes an inlet aperture 255 formed on an inner wall 257 (e.g., an adapter portion) of the cap 250 and an outlet aperture 260 formed as part of the outer wall 262. The inlet aperture 255 and the outlet aperture 260 are not aligned along a common axis and do not overlap one another when viewed from directly above looking down a longitudinal axis of the device. The actuator 245 includes an interface portion that extends to the outer circumference of the cap 250, a food space 265, and a pocket 270. A biasing member 275 is positioned within the pocket 270 with one engaging the actuator 245 and a second engaging the cap 250 such that the biasing member 275 biases the actuator 245 toward the non-actuated position illustrated in FIG. 12. In this position, and with the container inverted, the inlet aperture 255 is aligned with the food space 265 to allow a known quantity of the pellets 35 to fall into and fill the food space 265.

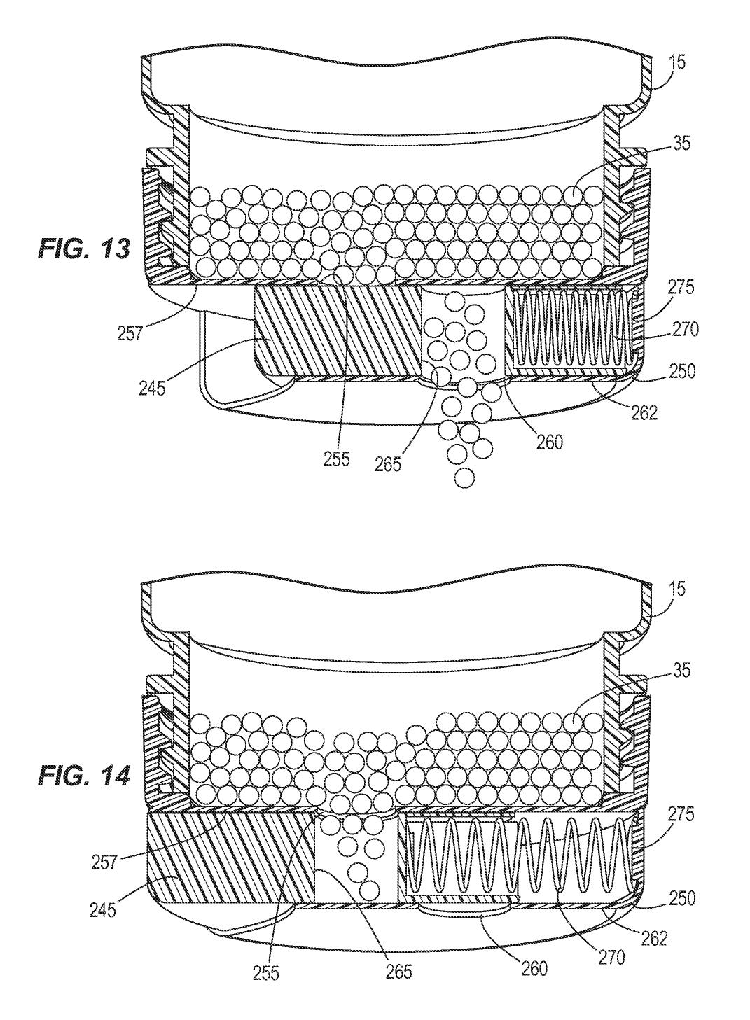

FIG. 13 illustrates the feeding tool 240 with the actuator 245 moved to the actuated position. In this position, the inlet aperture 255 is blocked by the actuator 245 and the food space 265 is aligned with the outlet aperture 260. Thus, the pellets 35 are free to fall out of the food space 265 and into the habitat. The user then releases the actuator 245, thereby allowing the biasing member 275 to bias the actuator 245 back to the non-actuated position as shown in FIG. 14. In this position, the outlet aperture 260 is once again blocked by the actuator 245 and the inlet aperture 255 is aligned with the food space 265 to allow the predetermined quantity of food to once again fill the food space 265.

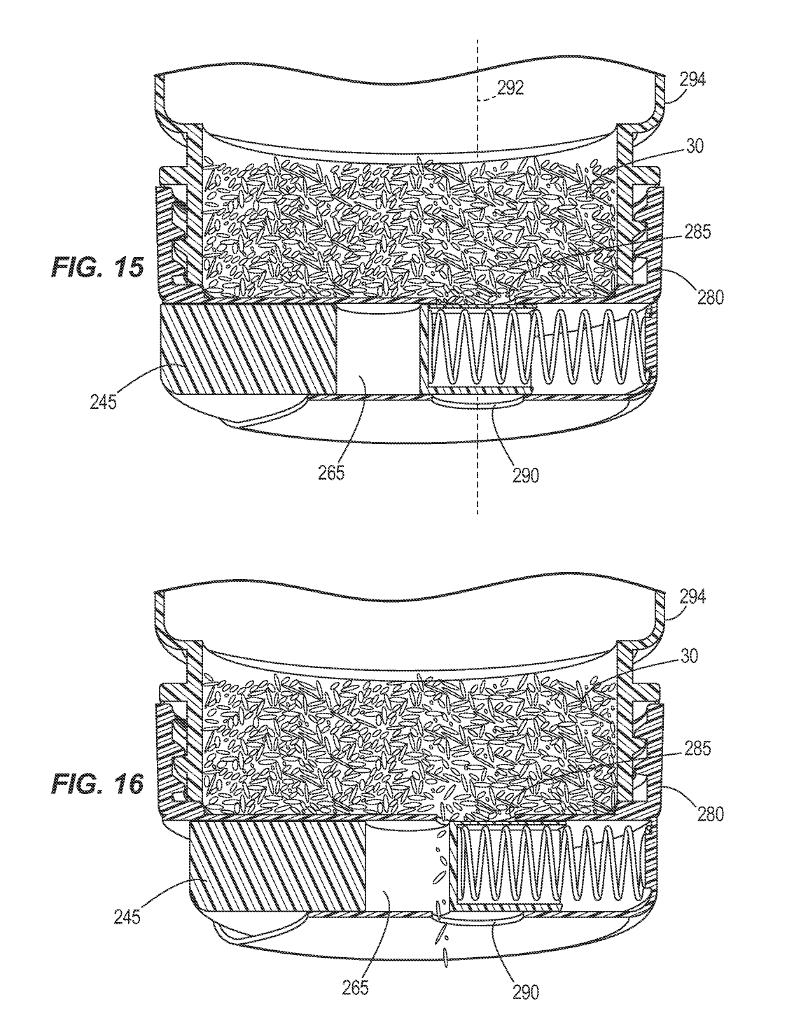

FIGS. 15-18 illustrate another arrangement of the cover 280 that is better adapted for delivering food in the form of flakes 30. The cover 280 includes an inlet aperture 285 and an outlet aperture 290 that are substantially aligned along a vertical axis 292 that is parallel to a long axis of a container 294 that holds the flakes 30. The actuator 245, the biasing member 275, and the remainder of the cap are substantially the same as those of FIGS. 12-14.

FIG. 15 illustrates the feeding tool with the cover 280 in a non-actuated position. In the non-actuated position the actuator 245 blocks both the inlet aperture 285 and the outlet aperture 290 and the food space 265 remains empty. FIG. 16 illustrates the feeding tool after the user has moved the actuator 245 to a first position. In this position, the food space 265 is partially aligned with the inlet aperture 285 and the outlet aperture 290 to define a small path for the passage of food. The user is thus able to deliver food to the habitat at a slow rate.

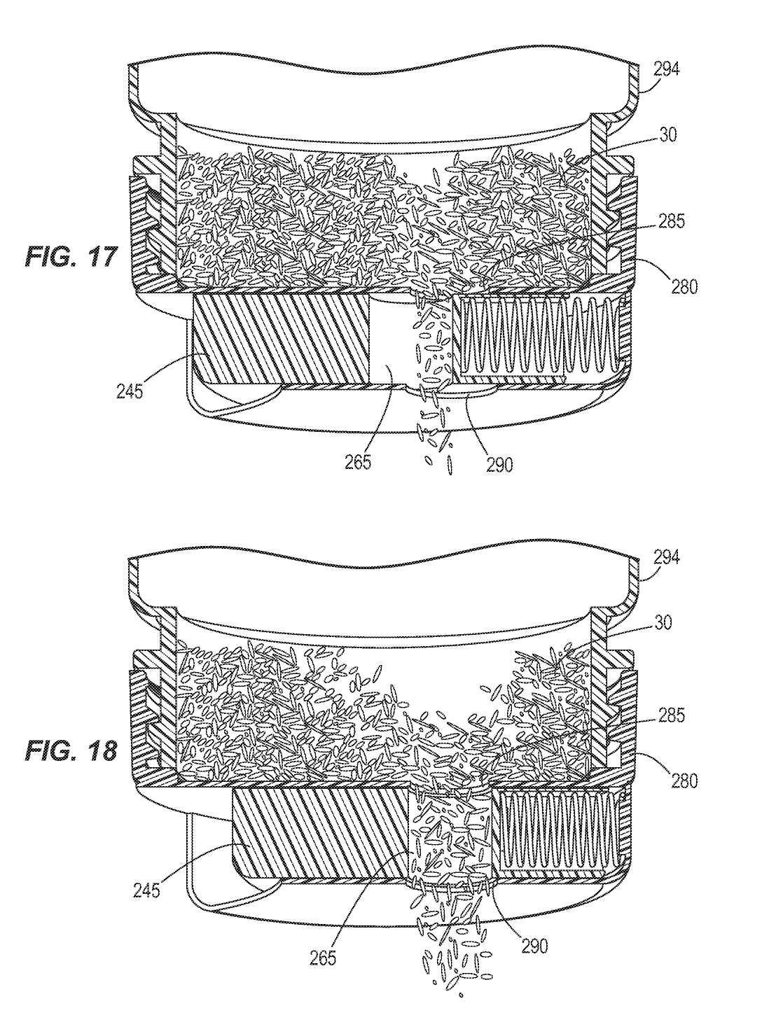

To accelerate feeding, the user can move the actuator 245 to a second actuated position as illustrated in FIG. 17. In this position, about half of the food space 265 is aligned with the inlet aperture 285 and the outlet aperture 290 to define a medium path for the passage of food. The user is thus able to deliver food to the habitat at a rate that is faster than the slow rate illustrated in FIG. 16.

To further accelerate the feeding, the user can move the actuator 245 to a third actuated position as illustrated in FIG. 18. In this position, the food space 265 is substantially aligned with the inlet aperture 285 and the outlet aperture 290 to define a large and substantially clear path for the passage of food. The user is thus able to deliver food to the habitat at a rate that is faster than the medium rate illustrated in FIG. 17.

In preferred constructions of the arrangement of FIGS. 15-18, the cover 280 or the actuator 245 includes an indicator that provides feedback to the user that a desired actuation position has been reached. For example, one construction includes a protrusion on one of the actuator 245 and the cover 280 and a corresponding recess on the other of the actuator 245 and the cover 280 at each of the three actuated positions. As the actuator 245 reaches one of the actuated positions, the protrusion engages the recess and provides an audible indication that the position has been reached. In addition, the resistance provided during movement of the actuator 245 changes when the protrusion meets the recess, thereby providing a physical feedback that the position has been reached. Of course, other arrangements such as visual indicators could be provided in place of, or in conjunction with the feedback mechanisms just described. In another construction, the actuator 245 is movable to any position between the non-actuated position and the third actuated position without any positional feedback being provided.

As can be seen, the construction illustrated in FIGS. 1-10 is arranged to effectively deliver food, or other objects in the form of pellets 35, much like the construction of FIGS. 12-14. However, as should be clear, the construction of FIGS. 1-10 could be modified to deliver flaked 30 products or food in much the same way as the construction of FIGS. 15-18. In fact, little more than the movement of the aperture 165 of the adapter 60 from its illustrated position to a position that aligns with the outlet aperture 225 is required to transition to a design adapted for the delivery of flakes 30 rather than pellets 35.

It should also be noted that the constructions illustrated herein include actuators that reciprocate in a linear fashion along an axis that is normal to the longitudinal axis of the container. However, other constructions are contemplated in which the actuator rotates around a substantially vertical axis. In these constructions, one or more food apertures could be provided in a rotating actuator. A first surface between the container and the actuator would include one or more inlet apertures arranged circumferentially around the axis and a second surface outside of the actuator would include one or more outlet apertures that are aligned with the inlet apertures for the delivery of flakes or misaligned with the inlet apertures for the delivery of pellets.

In constructions arranged to deliver pellets, the inlet apertures would align with the food spaces of the actuator when in the non-actuated position with the actuator covering the outlet apertures. As the actuator moves to the actuated position, the food spaces would move into alignment with the outlet apertures and the actuator would cover the inlet apertures. A torsional spring could be employed to bias the actuator toward the non-actuated position.

In constructions arranged to deliver flakes, the inlet apertures and the outlet apertures are aligned with one another and the food spaces are mis-aligned when the actuator is in a non-actuated position. The actuator thus covers the inlet apertures and the outlet apertures. As the actuator moves toward the fully actuated position, the food spaces align with the inlet apertures and the outlet apertures to define a path for the delivery of food.

While the constructions illustrated herein include a single inlet aperture and outlet aperture, constructions that employ multiple inlet and outlet apertures could space the apertures such that additional incremental movement of the actuator (linear or rotary) produces an incrementally larger flow path, thereby providing additional adjustment of the quantity of food being delivered.

It should be noted that the different embodiments described herein are not mutually exclusive. As such, features described with regard to one embodiment are equally applicable to any other embodiment described herein.

The feeding tools described herein are described as being suited to the delivery of food in the form of pellets or flakes to a pet habitat and in particular to a fish tank. However, the device is well-suited to delivering non-food items and for delivering items that are not pellet-shaped or flake-shaped. Thus, the invention should not be limited to delivering only food in the shape of pellets or flakes.

Additionally, while the embodiments described above are described in the context of a “store use” feeding tool, the feeding tool is equally applicable to consumer feeding lids. Thus, the feeding tool can be sold commercially to consumers, and can be used in residential households and environments to provide food to pets such as fish or other animals.

1. A feeding tool for dispensing pet food out of a pet food container, the feeding tool comprising:
an adapter having a first aperture, the adapter configured to couple to a container of pet food;
an actuator coupled to the adapter, the actuator movable between a first position and a second position;
a control member coupled to the actuator, the control member having a second aperture; and
a cap coupled to the actuator, the cap including a third aperture;
wherein the first and second apertures are aligned with one another in the first position to permit food to pass from the container into the actuator, and wherein the second and third apertures are aligned with one another in the second position to allow food to pass from the actuator, through the third aperture and out of the cap.

2. The feeding tool of claim 1, further comprising a biasing member that biases the actuator toward the first position.

3. The feeding tool of claim 1, wherein the control member is removably coupled to the actuator and includes a mid-section that includes the second aperture, and attachment legs positioned at each of the mid-section that cooperate with the mid-section to define fourth apertures.

4. The feeding tool of claim 3, wherein the actuator includes an operating portion having a substantially planar bottom surface and a slot that extends across the bottom surface sized to receive the mid-section of the control member.

5. The feeding tool of claim 4, wherein the actuator further includes a pair of attachment hooks adjacent the slot that are sized to engage the fourth apertures on the control member to hold the control member in place.

6. The feeding tool of claim 1, wherein the actuator includes an interface portion that extends out of the cap and provides a point where a user can actuate the feeding tool to deliver food or other product out of the feeding tool.

7. The feeding tool of claim 1, wherein the adapter is an inner wall of the cap, the inner wall including the first aperture, and wherein the cap includes an outer wall that includes the third aperture.

8. The feeding tool of claim 1, wherein the adapter includes a plurality of L-shaped slots, and wherein the cap includes a plurality of tabs that engage the L-shaped slots.

9. The feeding tool of claim 1, wherein the cap includes a top surface and two L-shaped members that extend from the top surface and define guide slots for the actuator, and wherein the actuator includes rails that slide within the guide slots.

10. The feeding tool of claim 1, wherein the first and third apertures are aligned along a common axis.

11. The feeding tool of claim 1, wherein the first and third apertures are not aligned along a common axis, and do not overlap with one another.

12. A feeding tool for dispensing pet food out of a pet food container, the feeding tool comprising:
an adapter having a first aperture, the adapter configured to couple to a container of pet food;
an actuator coupled to the adapter and movable between a first position and a second position;
a plurality of separate control members configured to be coupled to the actuator, each control member having a second aperture of different size;
a biasing member that biases the actuator toward the first position; and
a cap coupled to the actuator, the cap including a third aperture, at least one of the plurality of control members configured to be coupled to the cap.

13. The feeding tool of claim 12, wherein the cap includes a top surface and at least one control member support that extends from the top surface, the control member support having a thickness sized to support and store one or more unused control members.

14. The feeding tool of claim 12, wherein each of the control members includes a mid-section that includes the second aperture, and attachment legs positioned at each of the mid-section.

15. The feeding tool of claim 12, wherein the first and third apertures are aligned along a common axis.

16. The feeding tool of claim 12, wherein the first and third apertures are not aligned along a common axis, and do not overlap with one another.

17. A tool for dispensing dry goods, the tool comprising:
a container sized to contain a quantity of dry goods;
an actuator including a first aperture sized to hold a predetermined quantity of the dry goods, the actuator coupled to the container and movable between a first position in which dry goods pass from the container to the first aperture and a second position in which dry goods cannot pass from the container to the first aperture; and
a cap coupled to the container and supporting the actuator for movement relative thereto, the cap defining a second aperture that is not aligned with the first aperture when the actuator is in the first position and is aligned with the first aperture when the actuator is in the second position to receive the dry goods from the first aperture.

18. The tool of claim 17, wherein the actuator includes a control member coupled to the actuator, the control member defining the first aperture.

19. The tool of claim 17, further comprising a biasing member coupled to the actuator and operable to bias the actuator toward the first position.

20. The tool of claim 17, wherein the container includes an adapter that defines a third aperture, the third aperture aligned with the first aperture when the actuator is in the first position and misaligned with the first aperture when the actuator is in the second position, and wherein the cap is directly connected to the adapter.
